(19) United States
(12) Patent Application Publication
(10) Pub. No.: US 2026/0351029 A1
(43) Pub. Date: Nov. 5, 2026

(54) Systems and Methods for Automated Identification of Cell Types

(71) Applicant: The Board of Trustees of the Leland Stanford Junior University, Stanford, CA (US)

(72) Inventors: Ruijiang Li, Sunnyvale, CA (US); Yuming Jiang, Stanford, CA (US); Seyed Mirjahanmardi, Stanford, CA (US); Sen Yang, Stanford, CA (US); Yuchen Li, Stanford, CA (US)

(73) Assignee: The Board of Trustees of the Leland Stanford Junior University, Stanford, CA (US)

(21) Appl. No.: 19/487,447

(22) PCT Filed: May 28, 2024
(86) PCT No.: PCT/US2024/031281

§ 371 Date: Nov. 24, 2025

Related U.S. Application Data
(60) Provisional application No. 63/504,621, filed on May 26, 2023.

(51) Int. Cl. G06V 20/69; G06V 10/26; G06V 10/764; G06V 10/774; G06V 10/82

(52) U.S. Cl. CPC G06V 20/698; G06V 10/26; G06V 10/764; G06V 10/774; G06V 10/82; G06V 20/695

(57) ABSTRACT

Systems and methods for automated identification of cell types in accordance with embodiments of the invention are illustrated. One embodiment includes a method for automatically typing cells in pathology slides, including obtaining a hematoxylin and eosin stained (H&E) image of a test pathology slide, providing the H&E image to an identification model, and obtain an annotated image of the pathology slide from the identification model, where the annotated image includes cell type labels for cells in the H&R image, where the identification model is trained by obtaining a plurality of multiplexed immunofluorescence (mIF) images of a training pathology slide, obtaining a training H&E image of the training pathology slide, identifying cell types in the plurality of mIF images using biomarkers in the plurality of mIF images, co-registering the plurality of mIF images to the training H&E image, and providing the co-registered images to the identification model.

### CROSS-REFERENCE TO RELATED APPLICATIONS

The current application claims the benefit of and priority under 35 U.S.C. § 119(e) to U.S. Provisional Patent Application No. 63/504,621 entitled “Systems and Methods for the Automated Identification of Cell Types” filed May 26, 2023. The disclosure of U.S. Provisional Patent Application No. 63/504,621 is hereby incorporated by reference in its entirety for all purposes.

### FIELD OF THE INVENTION

The present invention generally relates to the automated identification of cell types in pathology slides.

### BACKGROUND

Histopathology is the microscopic examination of tissue in order to study disease. Histopathological examination of patient tissue involves excising a piece of tissue and preparing it for viewing under a microscope, typically on a slide. Histopathology with hematoxylin and eosin (H&E) staining is the standard approach in clinical practice for diagnosis and characterization of many diseases, including cancer. There are many histopatholgical tools that are used in the investigation of tissue. Multiplexed immunofluorescence (mIF) imaging is an imaging technique that enables multi-label analysis of tissues. Co-detection by indexing (CODEX) is an extension which enables simultaneous imaging of 40+ protein biomarkers in a tissue sample.

Neural networks are a class of machine learning algorithm that utilizes interconnected nodes, typically arranged in layers, connected by edges. Signals travel from the input layer to the output layer, sometimes passing through intermediate layers. Modifications to the signal occur at nodes based on parameters that are tuned during a training process in order to achieve a desired result. A convolutional neural network (CNN) is a class of neural network that includes at least one convolutional layer, and are well suited for image classification processes.

### SUMMARY OF THE INVENTION

Systems and methods for automated identification of cell types in accordance with embodiments of the invention are illustrated. One embodiment includes a method for automatically typing cells in pathology slides, including obtaining a hematoxylin and eosin stained (H&E) image of a test pathology slide, providing the H&E image to an identification model, and obtain an annotated image of the pathology slide from the identification model, where the annotated image includes cell type labels for cells in the H&R image, where the identification model is trained by obtaining a plurality of multiplexed immunofluorescence (mIF) images of a training pathology slide, obtaining a training H&E image of the training pathology slide, identifying cell types in the plurality of mIF images using biomarkers in the plurality of mIF images, co-registering the plurality of mIF images to the training H&E image, and providing the co-registered images to the identification model.

In a further embodiment, co-registering the plurality of mIF images to the training H&E image includes segmenting the training H&E image to locate nuclei of each cell in the training H&E image, obtaining a cell mask from the plurality of mIF images, and aligning the identified cell nuclei to the cell mask.

In still another embodiment, the cell mask is a 4′,6-diamidino-2-phenylindole (DAPI) staining mIF image.

In a still further embodiment, the method further includes steps for generating the plurality of mIF images using co-detection by indexing (CODEX).

In yet another embodiment, the identification model includes a HoVer-Net encoder-decoder structure.

In a yet further embodiment, the identification model further includes a SEResNext50 backbone.

In another additional embodiment, a method for training a cell typing model, includes obtaining a plurality of multiplexed immunofluorescence (mIF) images of a pathology slide, obtaining an H&E image of the pathology slide, identifying cell types in the plurality of mIF images using biomarkers in the plurality of mIF images, co-registering the plurality of mIF images to the H&E image, and providing the co-registered images to the identification model.

In another additional embodiment, co-registering the plurality of mIF images to the H&E image includes segmenting the H&E image to locate nuclei of each cell in the H&E image, obtaining a cell mask from the plurality of mIF images, and aligning the identified cell nuclei to the cell mask.

In a further additional embodiment, the cell mask is a 4′,6-diamidino-2-phenylindole (DAPI) staining mIF image.

In another embodiment again, the method further includes steps for generating the plurality of mIF images using co-detection by indexing (CODEX).

In a further embodiment again, the identification model includes a HoVer-Net encoder-decoder structure.

In still yet another embodiment, the identification model further includes a SEResNeXt50 backbone.

In still yet another embodiment again, a cell identification system includes a processor, and a memory containing a cell identification application which configures the processor to obtain a test hematoxylin and eosin stained (H&E) image of a test pathology slide, provide the test H&E image to an identification model, and obtain an annotated image of the test pathology slide from the identification model, where the annotated image includes cell type labels for cells in the test H&E image, where the cell identification model is trained by obtaining a plurality of multiplexed immunofluorescence (mIF) images of a training pathology slide, obtaining a training H&E image of the training pathology slide, identifying cell types in the plurality of mIF images using biomarkers in the plurality of mIF images, co-registering the plurality of mIF images to the training H&E image, and providing the co-registered training images to the identification model.

In a still yet further embodiment, the system further includes steps for a co-detection by indexing (CODEX) system configured to generate the plurality of mIF images.

In still another additional embodiment, co-registering the plurality of mIF images to the training H&E image includes segmenting the training H&E image to locate nuclei of each cell in the training H&E image, obtaining a cell mask from the plurality of mIF images, and aligning the identified cell nuclei to the cell mask.

In a still further additional embodiment, the cell mask is a 4′,6-diamidino-2-phenylindole (DAPI) staining mIF image.

In still another embodiment again, the system further includes steps for generating the plurality of mIF images using co-detection by indexing (CODEX).

In a still further embodiment again, the identification model includes a HoVer-Net encoder-decoder structure.

In yet another additional embodiment, the identification model further includes a SEResNext50 backbone.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 illustrates an automated cell typing system in accordance with an embodiment of the invention.

FIG. 2 is a block diagram for a cell typer in accordance with an embodiment of the invention.

FIG. 3 is a flow chart for a cell typing training process in accordance with an embodiment of the invention.

FIG. 4 is a set of canonical cell lineage markers in accordance with an embodiment of the invention.

FIG. 5 is a chart showing cell type assignment in accordance with an embodiment of the invention.

FIG. 6 is an example identification model architecture in accordance with an embodiment of the invention.

FIG. 7 is a flow chart for an automated cell typing process in accordance with an embodiment of the invention.

### DETAILED DESCRIPTION

Histopathology plays a critical role in diagnosis of many diseases including cancer. In many cases, histopathology is used to differentiate between different grades of cancers and to assist in the prognostic process. While histopathology was originally performed by humans, recent approaches have attempted to train models based on human-annotated training data sets of labeled slides. For example, convolutional neural networks (CNNs) have been trained to obtain tissue-and cell-type spatial information and produce predicted cell types for each cell in the slide. However, these cell labels tend to be unreliable, not specific enough, and are unscalable. A vast amount of verified, ground-truth data is needed in these training processes which all need to be annotated using a single labeling scheme. In order to address these shortcomings, systems and methods described herein classify cells in slides using models that do not require human annotations.

Hematoxylin and eosin staining (H&E) is a common clinical practice for diagnosis of disease. Multiplexed immunofluorescence (mIF) imaging of H&E slides enables the extraction of cell-level protein information. In many embodiments, an image of an H&E slide is spatially co-registered with mIF images of the same H&E slide which enables transference of the ground truth of cell types to the H&E slide image without any human annotations. In numerous embodiments, many different co-registered H&E slides are generated and used in training an unsupervised deep learning model to differentiate different types of cells. In various embodiments, a high-plex mIF imaging modality is used. For example, in various embodiments, the mIF is performed using co-dectection by indexing (CODEX) to enable a high number of biomarkers to be identified in a single slide. CODEX is a registered trademark of Akoya Biosciences, Inc. of Delaware, who produce the CODEX system.

In numerous embodiments, an unsupervised clustering approach can be used to define cell types, such as (but not limited to) a Gaussian mixture model fit on protein marker intensity. In various embodiments, an unsupervised lineage assignment method is used. In many embodiments, the mIF images include at least 5 cell lineage protein markers: pan-CK, CD3, CD20, CD66b, and CD68, which can at least be used to differentiate between tumor cells, lymphocytes, neutrophils, and macrophages.

When using CODEX, additional protein markers can be included in order to increase the number and/or accuracy of cell typings. In numerous embodiments, the protein markers include: PanCK, Collagen IV, FAP, SMA, MMP9, Ki67, CD3e, CD4, CD8, FoxP3, CD138, CD20, GZMB, PD-1, PD-L1, LAG3, CD163, CD68, CD11c, and CD66b. In many embodiments, cell types occurring at low frequency and with indistinguishable morphology are consolidated into three distinct categories of 11 cell types, including malignant cells (including both non-proliferating and proliferating malignant cells); stromal cells (comprising fibroblasts and endothelial cells); and immune cells (including neutrophils, monocytes, macrophages with M1 and M2 subtypes, T cells, B cells, and plasma cells).

Spatial co-registration of the H&E slide image and the mIF images annotated with cell types can be achieved using a CNN trained to segment all cell nuclei. As cell-level accuracy is beneficial, to achieve this level of precision the co-registration result can be fine-tuned by applying translation, scaling, and rotation procedures to match the cell's centroid calculated from a segmentation mask on H&E images to their counterpart on the mIF images. In numerous embodiments, the cell nuclei in the mIF images are identified using segmentation masks on CODEX DAPI images. This approach can be used instead of a CNN segmenter for mIF images. In many embodiments, only cells within a maximal proximity of 10 pixels are accepted as congruent.

Using the co-registered images, a deep learning model can be trained to identify cell types based on H&E images only. The result of the training process is a model which can take only H&E images automatically identify each cell in the slide. In numerous embodiments, the model is a streamlined HoVer-Net architecture with a unified decoder and an SEResNeXt50 backbone. In various embodiments, dropout layers are used for regularization and both intra- and inter-model ensemble techniques are employed to analyze augmented images for robust performance. In many embodiments, the model's post-processing employs algorithms for cellular segmentation and classification. Systems for automated cell typing are discussed below, followed by a discussion of automated cell typing methods.

### Automated Cell Typing Systems

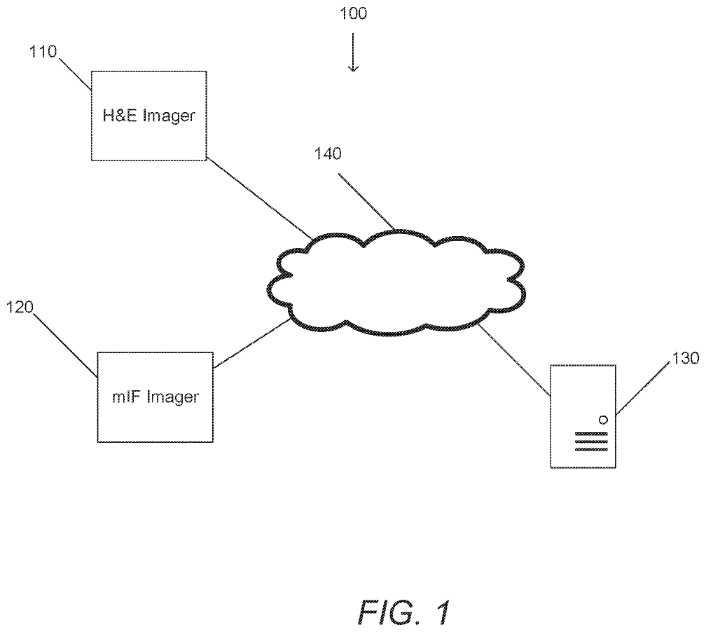

Turning now to FIG. 1, a system architecture for an automated cell typing system in accordance with an embodiment of the invention is illustrated. System 100 includes an H&E imager 110 and a mIF imager 120. In numerous embodiments, the H&E imager and mIF imager may be the same microscope camera. System 100 further includes a cell typer 130. Cell typer 130 is communicatively coupled to the H&E imager 110 and mIF imager 120 via a network 140. In various embodiments, the network is a wireless network. However, a wired network or a combination of wireless and wired networks can be used. In some embodiments, the network 140 is the Internet. In many embodiments, the network 140 is an intranet.

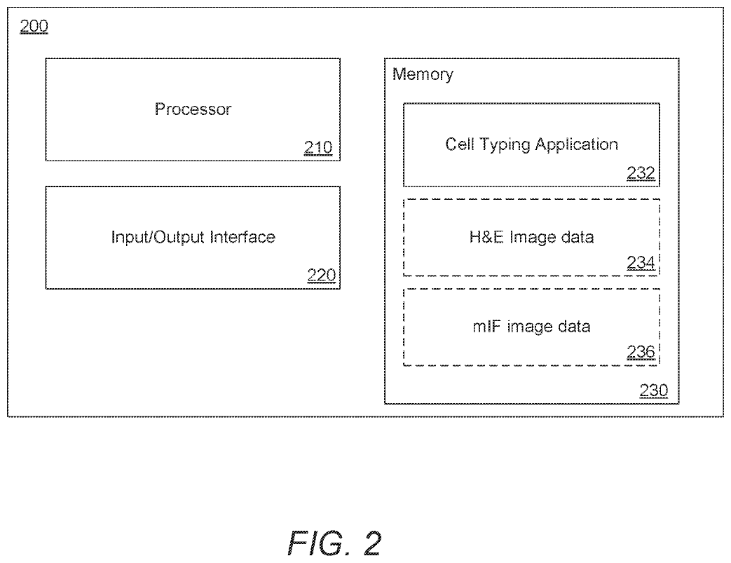

FIG. 2 illustrates a block diagram for a cell typer in accordance with an embodiment of the invention. The cell typer 200 includes a processor 210. Processors can be any logical processing circuitry capable of performing cell typing processes described herein. For example, processors can be central processing units (CPUs), graphics processing units (GPUs), field-programmable gate-arrays (FPGAs), application-specific integrated circuits (ASICs), and/or any other logic circuit or combination thereof as appropriate to the requirements of specific applications of embodiments of the invention. Cell typer 200 further includes an input/output (I/O) interface 220. I/O interfaces are ports which enable communication with other devices such as, but not limited to, computers, servers, networks, displays, user interface devices (i.e. keyboards, mice, etc.), H&E imagers, mIF imagers, and/or any other devices as appropriate to the requirements of specific applications of embodiments of the invention. In many embodiments, the I/O interface can communicate using multiple modalities.

Cell typer 200 further includes a memory 230 communicatively coupled to the processor. The memory can be volatile memory, non-volatile memory, or a combination thereof. The memory 230 stores a cell typing application 232 that contains instructions capable of configuring the processor to perform various cell typing processes as described herein. In many embodiments, during various phases of operation, the memory also stores H&E image data 234 and mIF image data 236. While particular hardware is illustrated in FIGS. 1 and 2, as can be readily appreciated, any number of different hardware configurations can be used to obtain mIF images and H&E images, and subsequently carry out cell typing processes. For example, in many embodiments, a system may only include an H&E imager and only acquire H&E images once the cell typing model has been sufficiently trained. Methods for automated cell typing and training the model are discussed in further detail below.

### Automated Cell Typing Methods

Methods for automated cell typing herein involve the training of a deep learning model to identify cell types based only on an input H&E image by using coregistered H&E images and mIF images. Once trained, mIF images are no longer needed to achieve cell typing. As noted above, technologies have been developed which significantly increase the ease and efficiency of obtaining high-plex mIF images, such as CODEX. While high-plex imaging is not required, obtaining additional biomarkers can enable higher sensitivity training. That is, the model can be trained to identify more cell types based only on H&E images with additional training data. Because the training process relies on coregistered H&E images and mIF images, high-plex imaging enables more data to be extracted from the single slide.

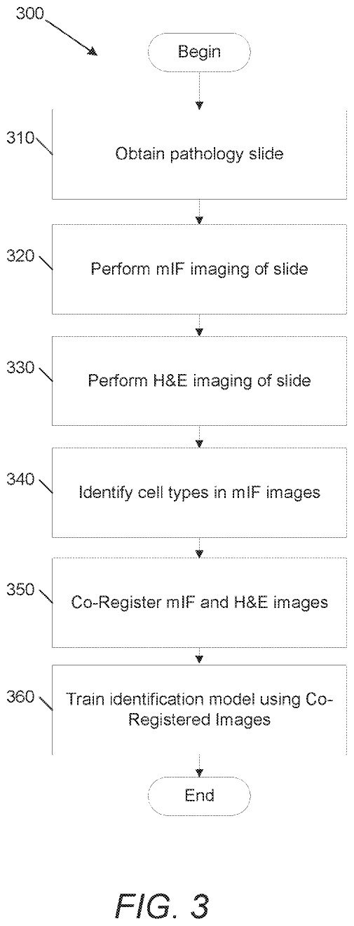

Turning now to FIG. 3, a process for training a deep learning model to identify cell types based on H&E images in accordance with an embodiment of the invention is illustrated. Process 300 includes obtaining a pathology slide. The pathology slide contains human tissue to be investigated. The slide is imaged (320) using mIF and then the same slide is imaged (330) using H&E. This produces mIF images and an H&E image respectively, which can be stored as image data. In numerous embodiments, the mIF imaging is performed using CODEX, which produces mIF image data as CODEX data.

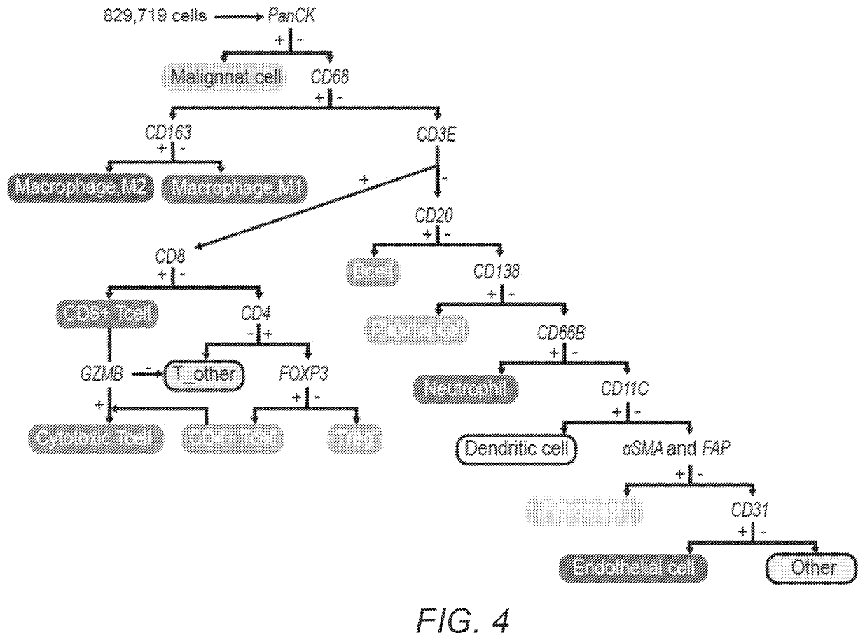

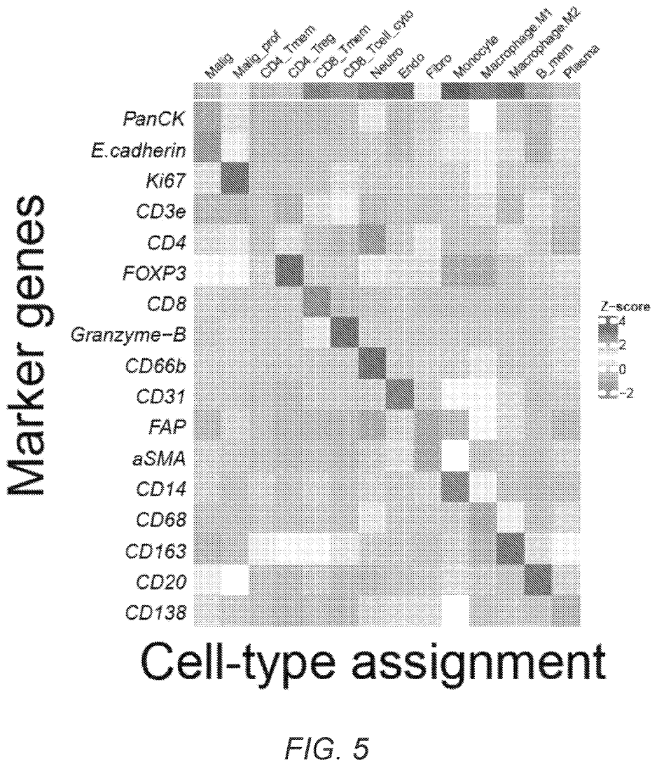

Cell types in the mIF images are identified using the biomarkers. In numerous embodiments, the cell typing process includes subtracting background from the images and registering the images. They are then segmented and quantified. Based on the biomarkers for each cell, an unsupervised clustering algorithm can be used to identify cell types. In many embodiments, canonical cell lineage markers are used by the algorithm. An example set of canonical cell lineage markers in accordance with an embodiment of the invention in FIG. 4. A cell type assignment based on the marker genes in accordance with an embodiment of the invention in FIG. 5. In numerous embodiments, the cell type assignments are used to annotate the mIF images as metadata, where each cell in the image is labeled with its identified cell type.

The mIF and H&E images are then co-registered (350). In many embodiments, the co-registration process includes segmenting the H&E image to identify the nucleus position of each cell in the image. In numerous embodiments, this is achieved using a convolutional neural network. A similar approach can be used for the mIF images. However, in various embodiments, CODEX 4′,6-diamidino-2-phenylindole (DAPI) staining produces cell mask images which can be used to identify cell positions in the mIF image data. In this case, the mIF images can be translated, scaled, rotated, or otherwise warped to the matched corresponding nucleus positions in the H&E image. In this way, cells in the H&E image and mIF images are co-registered, and therefore each cell in the H&R image is labeled, providing a ground truth training point. Many of these ground truth training slides are generated and used to train (360) the deep learning identification model.

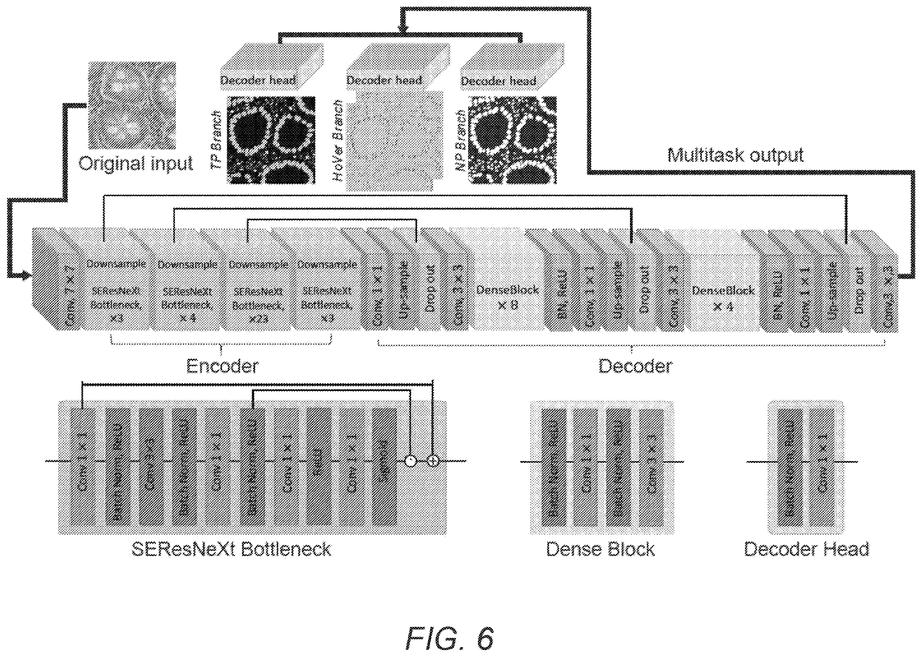

In many embodiments, the identification model is a streamlined HoVer-Net-based encoder-decoder structure with a unified decoder branch and intensive dropout for training regularization, incorporating a SEResNeXt50 backbone for enhanced adaptability. An example network architecture for the model in accordance with an embodiment of the invention is illustrated in FIG. 6. However, as can be readily appreciated, other neural network configurations can be used without departing from the scope or spirit of the invention.

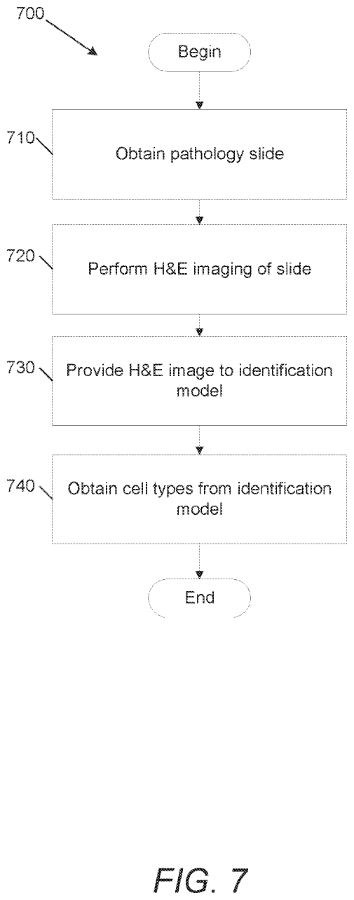

Turning now to FIG. 7, a process for automated cell typing using the trained model in accordance with an embodiment of the invention is illustrated. Process 700 includes obtaining (710) a pathology slide. The slide is H&E stained and imaged (720). The H&E image of the slide is provided (730) to the trained identification model, and the cell types in the image are obtained (740) as the model output. In this way, no additional staining or testing of the sample is required to identify the cell types.

Although specific systems and methods for automatic cell typing are discussed above, many different methods and architectures can be implemented in accordance with many different embodiments of the invention. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method for automatically typing cells in pathology slides, comprising:
obtaining a hematoxylin and eosin stained (H&E) image of a test pathology slide;
providing the H&E image to an identification model; and
obtain an annotated image of the pathology slide from the identification model, where the annotated image comprises cell type labels for cells in the H&R image;
where the identification model is trained by:
obtaining a plurality of multiplexed immunofluorescence (mIF) images of a training pathology slide;
obtaining a training H&E image of the training pathology slide;
identifying cell types in the plurality of mIF images using biomarkers in the plurality of mIF images;
co-registering the plurality of mIF images to the training H&E image; and
providing the co-registered images to the identification model.

2. The method of claim 1, wherein co-registering the plurality of mIF images to the training H&E image comprises:
segmenting the training H&E image to locate nuclei of each cell in the training H&E image;
obtaining a cell mask from the plurality of mIF images; and
aligning the identified cell nuclei to the cell mask.

3. The method of claim 2, wherein the cell mask is a 4′,6-diamidino-2-phenylindole (DAPI) staining mIF image.

4. The method of claim 1, further comprising generating the plurality of mIF images using co-detection by indexing (CODEX).

5. The method of claim 1, wherein the identification model comprises a HoVer-Net encoder-decoder structure.

6. The method of claim 5, wherein the identification model further comprises a SEResNeXt50 backbone.

7. A method for training a cell typing model, comprising:
obtaining a plurality of multiplexed immunofluorescence (mIF) images of a pathology slide;
obtaining an H&E image of the pathology slide;
identifying cell types in the plurality of mIF images using biomarkers in the plurality of mIF images;
co-registering the plurality of mIF images to the H&E image; and
providing the co-registered images to the identification model.

8. The method of claim 7, wherein co-registering the plurality of mIF images to the H&E image comprises:
segmenting the H&E image to locate nuclei of each cell in the H&E image;
obtaining a cell mask from the plurality of mIF images; and
aligning the identified cell nuclei to the cell mask.

9. The method of claim 8, wherein the cell mask is a 4′,6-diamidino-2-phenylindole (DAPI) staining mIF image.

10. The method of claim 7, further comprising generating the plurality of mIF images using co-detection by indexing (CODEX).

11. The method of claim 7, wherein the identification model comprises a HoVer-Net encoder-decoder structure.

12. The method of claim 11, wherein the identification model further comprises a SEResNeXt50 backbone.

13. A cell identification system, comprising:
a processor; and
a memory containing a cell identification application which configures the processor to:
obtain a test hematoxylin and eosin stained (H&E) image of a test pathology slide;
provide the test H&E image to an identification model; and
obtain an annotated image of the test pathology slide from the identification model, where the annotated image comprises cell type labels for cells in the test H&E image;
where the cell identification model is trained by:
obtaining a plurality of multiplexed immunofluorescence (mIF) images of a training pathology slide;
obtaining a training H&E image of the training pathology slide;
identifying cell types in the plurality of mIF images using biomarkers in the plurality of mIF images;
co-registering the plurality of mIF images to the training H&E image; and
providing the co-registered training images to the identification model.

14. The cell identification system of claim 13, further comprising a co-detection by indexing (CODEX) system configured to generate the plurality of mIF images.

15. The system of claim 14, wherein co-registering the plurality of mIF images to the training H&E image comprises:
segmenting the training H&E image to locate nuclei of each cell in the training H&E image;
obtaining a cell mask from the plurality of mIF images; and
aligning the identified cell nuclei to the cell mask.

16. The system of claim 15, wherein the cell mask is a 4′,6-diamidino-2-phenylindole (DAPI) staining mIF image.

17. The system of claim 13, further comprising generating the plurality of mIF images using co-detection by indexing (CODEX).

18. The system of claim 13, wherein the identification model comprises a HoVer-Net encoder-decoder structure.

19. The system of claim 18, wherein the identification model further comprises a SEResNeXt50 backbone.
